(19) United States
(12) Patent Application Publication
(10) Pub. No.: US 2002/0002615 A1
(43) Pub. Date: Jan. 3, 2002

(54) METHOD AND APPARATUS FOR SWITCHING BETWEEN INTERNET SERVICE PROVIDER GATEWAYS

(76) Inventors: VIJAY K. BHAGAVATH, LINCROFT, NJ (US); JOSEPH THOMAS O'NEIL, STATEN ISLAND, NY (US)

Correspondence Address: FRANK PIETRANTONIO, KENYON & KENYON, 1500 K STREET,N.W., WASHINGTON, DC, 20005

(21) Appl. No.: 09/156,972

(22) Filed: Sep. 18, 1998

(51) Int. Cl. G06F 15/16

(52) U.S. Cl. 709/227; 709/218

(57) ABSTRACT

A method and apparatus for switching a connection between a client computer and a first intermediary computer to a connection between the client computer and a second intermediary computer is described. A user interface is displayed by the client computer. The user interface can be in the form of a graphics user interface (GUI) that accepts inputs for selecting between the first and second intermediary computers. A user selects the second intermediary computer. A client proxy stores an internet address associated with the client computer as assigned by the ISP controlling the second intermediary computer in a translation table. The client proxy then performs address translation for any packets communicated between the client computer and the second intermediary computer using the translation table.

### FIELD OF THE INVENTION

The invention relates to communications networks in general. More particularly, the invention relates to a method and apparatus for a client computer to switch between a plurality of Internet service provider gateways.

### BACKGROUND OF THE INVENTION

The Internet is a vast and complex collection of networks, computers and communications lines. Because of its ubiquitous and uniform nature, the Internet provides the capability of communicating voice, image and data information between disparate geographic locations in a cost effective manner. As such, the popularity of the Internet is experiencing tremendous growth.

There are many different ways for a user to connect to the Internet. For example, a user can initiate a connection using a personal computer (PC) equipped with a modem, Internet “browser” software, and an integrated communications package. A user enters a command for the browser to open a connection to another computer, e.g., a host computer. The browser sends instructions to the communications program to open a connection to an intermediary computer managed by an Internet Service Provider (ISP). The intermediary computer acts as a conduit for the PC to communicate with the host computer via the Internet backbone. Once a connection is established, a user can use the browser to retrieve information from the host computer, e.g., a “web page.”

The connection between the PC and the intermediary computer provided by the ISP (“ISP connection”) is particularly important to the overall quality of the connection between the PC and the host computer. For example, the speed of the ISP connection affects the overall speed at which the PC and the host computer can communicate information. In another example, the security characteristics of the ISP connection can affect the security of the overall connection. This is because the overall connection is only as fast or secure as any of the individual connections comprising the overall connection.

The speed and security characteristics of an ISP connection varies according to the type of media access technique used by each particular ISP. Media access technique refers to the hardware (e.g., modulator/demodulator or “modem”), software (e.g., a media access protocol) and transmission medium (e.g., copper twisted-pair wire, co-axial cable, fiber optic cables, radio-frequencies, and so forth), used to communicate information between the PC and host computer. Therefore, it is not unusual to find that a user desires to have the capability of accessing more than one ISP and selecting one based upon the type of media access technique provided by the various ISPs. For example, if a user desires a “high-speed” ISP connection, the user might initiate the ISP connection using an Integrated Services Digital Network (ISDN) modem to an ISP capable of supporting ISDN transmissions. ISDN modems typically provide speeds ranging from 64 Kilobytes per second (Kbps) to 128 Kbps over ISDN lines. Even faster ISP connections can be established using Asymmetric Digital Subscriber Line (ADSL) modems over existing telephone wires. ADSL is capable of downstream speeds (e.g., server to client) of up to 8 Megabytes per second (Mbps), and upstream speeds (e.g., client to server) of up to 1 Mbps. Cable modems provide the potential for faster speeds over existing cable television wires (i.e., co-axial cable). Cable modems can provide peak downstream access speeds of up to 10 Mbps per user. For the return upstream path, either voice-band analog modems could be used offering speeds ranging between 14.4 Kbps to 56 Kbps, or the cable modem itself could be used in a bi-directional arrangement with peak upstream speeds of up to 1 Mbps per user. If speed is less of a concern, the user may simply initiate an ISP connection using a modem operating in accordance with a Serial Line Internet Protocol (SLIP) or Point-to-Point Protocol (PPP), which can offer bi-directional communication speeds of up to 33.6 kilobits per second (Kbps) over existing telephone lines. The type of system architecture providing such alternate ISP connection capabilities is shown in FIG. 1, which is discussed below.

FIG. 1 illustrates a network that provides a network device the capability of connecting to more than one ISP. As shown in FIG. 1, a network 100 comprises network devices 102 and 104. Network devices 102 and 104 each include a browser (“B”) and a Network Interface Card (NIC) (not shown). In this example, network devices 102 and 104 are PCs (also referred to as “client computers”) connected to a local area network (LAN) 114. Lan 114 is connected to modems 106, 108, 110 and 112. Modems 106, 108, 110 and 112 are connected to ISP 116, 118, 120 and 122, respectively (also referred to as “intermediary computers” or “ISPG” (ISP Gateway)). In this example, the connection between modem 106 and ISP 116 uses a media access technique based on PPP technology, the connection between modem 108 and 118 uses ADSL technology, the connection between modem 110 and 120 uses ISDN technology, and the connection between modem 112 and 122 uses Cable modem technology. ISP 116, 118, 120 and 122 each utilize an ISPG that provides a connection to Internet 124. The ISP is an IP router. It is the first IP router that is encountered by packets-that enter the ISP point-of-presence (POP) from a customer.

Prior to discussing the operation of network 100, it may prove useful to provide a basic description of how the Internet operates in general. The Internet is a packet-switched network. In a packet-switched network, a sending computer generates information. The information is broken down into discrete pieces called packets, which are sent to a destination computer over the network. The destination computer then receives and reassembles the packets to retrieve the original information. The Internet accomplishes this using a communication protocol called the Internet Protocol (IP). IP provides an addressing scheme that ensures proper routing of the packets to the intended destination. Additionally, the sending and destination computers support protocols such as Transmission Control Protocol (TCP) and User Datagram Protocol (UDP), which work above the IP layer to ensure a sequenced and reliable delivery of packets.

In order for the client computer to take full advantage of the Internet, it needs special software that understands and interprets the Internet's IP protocols. This software is referred to as an “IP stack.” In order for the IP stack of the client computer to communicate with the IP stack of the ISPG, the client machine requires: (a) the IP address of the ISPG and (b) the IP address which has been assigned to that client machine by the ISP. The ISP requires this assignment so that an edge router for the ISP can perform packet filtering. Packets with source addresses that are outside of the range expected by the ISPG are not accepted by the ISPG. This helps protect the ISP from attacks by computer hackers. The IP address of the ISPG and IP address assigned to the client machine by the ISP are typically used to configure the client computer so it can communicate correctly with that ISP.

Referring again to FIG. 1, if a user wanted to initiate a high-speed connection between network device 102 and Internet 124, the user could select an ISP connection to ISP 122 using cable modem 112. In order to accomplish this, the user would need to pre-configure the IP stack for network device 102 with the source and destination addresses for ISP 122. This is relatively straightforward, and is accomplished using techniques well-known in the art.

A problem occurs, however, whenever the same user wants to initiate an ISP connection from network device 102 to a different ISP, e.g., ISP 118 using an ADSL connection. In order for network device 102 to communicate with ISP 118, the IP stack for network device 102 must be reconfigured with the IP addresses for the ISPG and client computer that have been assigned by ISP 118. This requires the user to remember or otherwise have access to the IP addresses for ISP 118, which can be cumbersome and difficult given that an IP address can comprise 12 or more digits, e.g., “100.101.102.103”. Moreover, many client computers utilizing an operating system provided by Microsoft such as Windows® 3.0, 3.1 and 95, all of which require that the client computer be turned off and back on (i.e., “rebooted”) so that the IP stack can recognize the new IP addresses for ISP 118. This “reboot” requirement takes a relatively long period of time.

The need to change the IP addresses associated with an ISPG at the client computer whenever a new ISP is selected is tedious and cumbersome to a user. In view of the foregoing, it can be appreciated that a substantial need exists for a method and apparatus which solves the above-discussed problems.

### SUMMARY OF THE INVENTION

The embodiments of the invention comprise a method and apparatus for switching a connection between a client computer and a first intermediary computer to a connection between the client computer and a second intermediary computer. A user interface is displayed by the client computer. The user interface can be in the form of a graphics user interface (GUI) that accepts inputs for selecting between the first and second intermediary computers. A user selects the second intermediary computer. A client proxy stores an internet address associated with the client computer as assigned by the ISP controlling the second intermediary computer in a translation table. The client proxy then performs address translation for any packets sent between the client computer and the second intermediary computer using the translation table.

With these and other advantages and features of the invention that will become hereinafter apparent, the nature of the invention may be more clearly understood by reference to the following detailed description of the invention, the appended claims and to the several drawings attached herein.

### BRIEF DESCRIPTION OF THE DRAWINGS

FIG. 1 illustrates a network that provides a client computer the capability of connecting to the Internet using one of a number of ISPs.

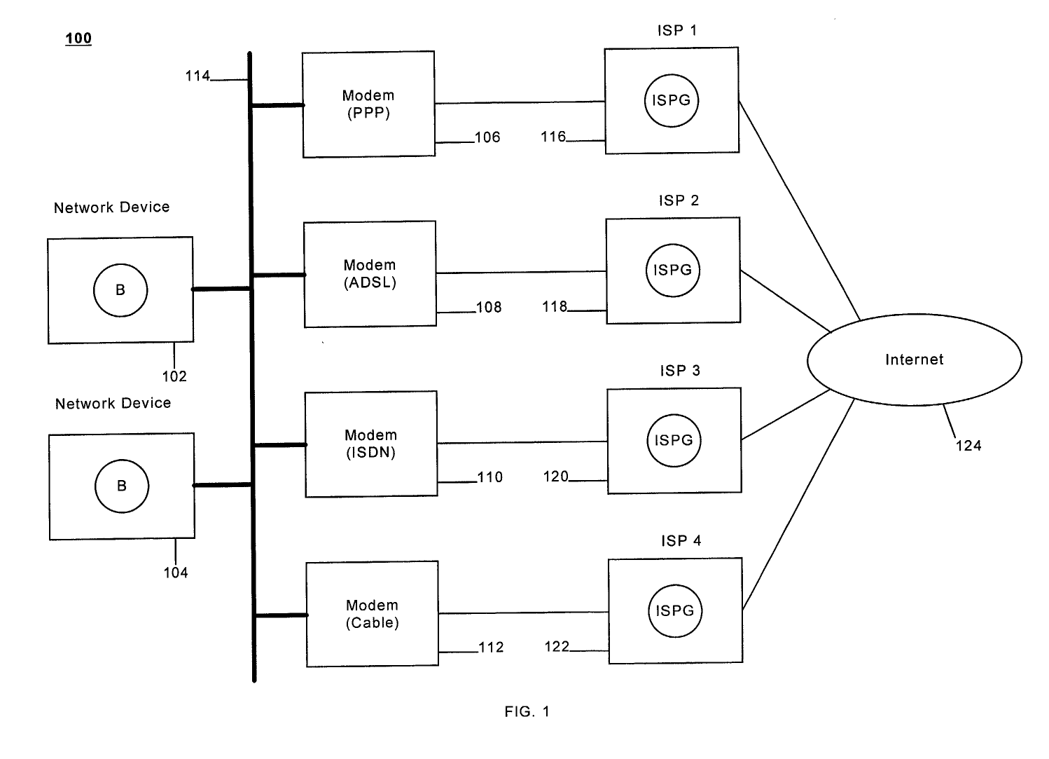

FIG. 2 is a block diagram of a client computer in accordance with one embodiment of the invention.

FIG. 3 is a diagram of a IP stack in accordance with one embodiment of the invention.

FIG. 4 illustrates a user interface for configuring a client proxy in accordance with one embodiment of the invention.

FIG. 5 illustrates a user interface for selecting an ISP in accordance with one embodiment of the invention.

FIG. 6 is a block flow diagram of the steps performed in accordance with one embodiment of the invention.

FIG. 7 is a block flow diagram of the operations of a client proxy performing address translation for a packet generated by a client computer in accordance with one embodiment of the invention.

FIG. 8 is a block flow diagram of the operations of a client proxy performing address translation for a packet received by a client computer in accordance with one embodiment of the invention.

### DETAILED DESCRIPTION

Many ISPs assign an IP address to each user. This information is provided at the time of subscription. In addition, the IP address for the ISPG or intermediary computer used by the ISP is also provided to the user. Both addresses are used to configure a client computer (e.g., PC) for connection to the ISPG. If a user wants to connect to another ISP, for example because that other ISP offers a different media access technique, the IP addresses for the client computer and the new ISPG both must be changed. Currently, PCs utilizing an operating system offered by Microsoft such as Windows 3.0, 3.1 or 95, require that the PC be rebooted whenever these addresses are changed.

The embodiments of the invention provide a method and apparatus for switching between a plurality of ISPs (and consequently multiple access media techniques) without requiring a reboot of a PC running Microsoft Windows. This is accomplished using a client proxy. The client proxy is a software program that acts as an intermediary between the IP stack of the client computer and IP stack of the intermediary computer. Whenever a user desires to switch to a new ISP, the appropriate addresses are changed in the client proxy, rather than in the actual IP stack of the client computer. By avoiding any changes to the IP stack of the client computer, the need to reboot the client computer is also avoided.

The client proxy is installed on the client computer and performs address translation for packets processed by the client computer's IP stack. Whenever a user desires to switch to a different ISP, the user selects the ISP using a helper application, and the IP address assigned to the PC by that selected ISP is stored in a translation table used by the client proxy. Further, the IP address of the ISPG is passed to the media access control (MAC) layer of the client computer's IP stack. As packets are processed by the client computer's IP stack, address packet translation is performed by the client proxy on those packets passing between the client computer and the new ISPG. More particularly, the IP address assigned to the client computer is retrieved from each packet and compared with an IP address stored in the translation table. If the addresses do not match, the IP address embedded in the packet is replaced by the IP address stored in the translation table.

The client proxy may be implemented as part of a web browser, or in cooperation with a web browser. A helper application provides a convenient interface that allows a user to define the client and gateway addresses that must be used to communicate with different ISPs. Examples of such user interfaces could be a GUI or a text field based user interface. In addition, the helper application also allows a user to dynamically select an ISP with which to communicate. The client proxy then sets the source address of each outgoing packet to the value expected by that ISP. It also sets the destination address of each incoming packet to the value expected by the client computer.

It is worthy to note that any reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment. Further, it can be appreciated that the embodiments described herein are for illustrative purposes only, and that other embodiments incorporating the principles described herein may exist and still fall within the scope of the invention.

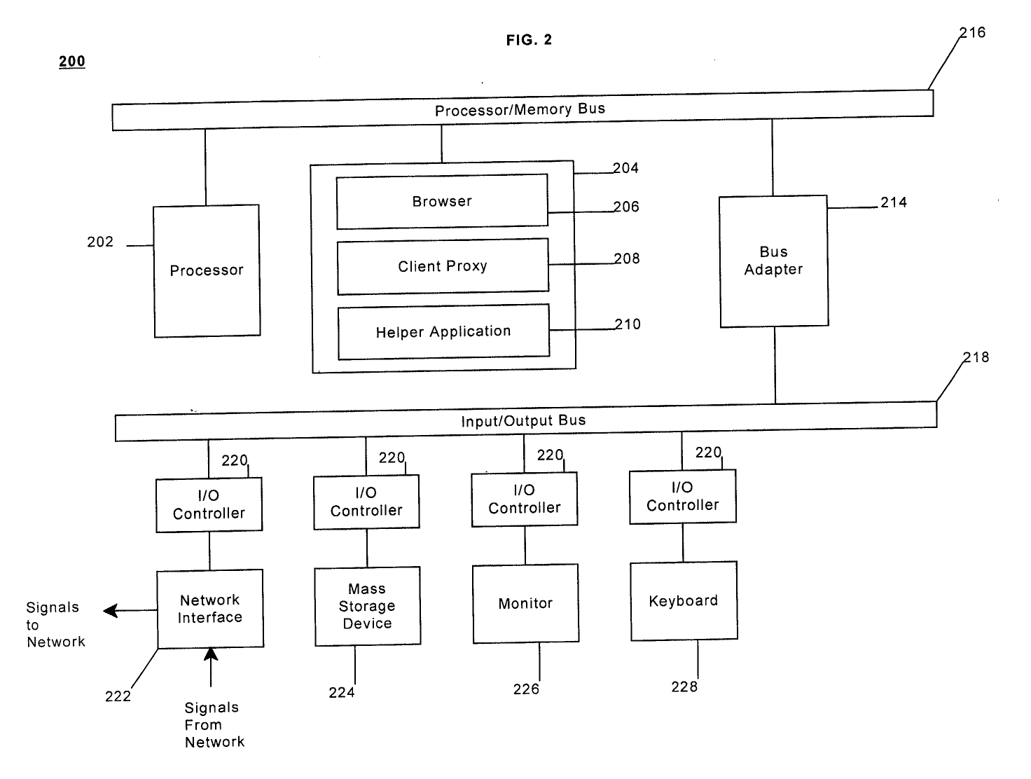

Referring now in detail to the drawings wherein like parts are designated by like reference numerals throughout, there is illustrated in FIG. 2 a block diagram of a client computer in accordance with one embodiment of the invention. FIG. 2 shows a client computer 200 comprising a processor 202, a memory 204, and a bus adapter 214, each of which is connected to a processor/memory bus 216 and an Input/Output (I/O) bus 218 via bus adapter 214. Further, client computer 200 contains a network interface 222, mass storage device 224, monitor 226, and keyboard 228, each of which is connected to I/O bus 218 via an I/O controller 220.

In one advantageous embodiment of the invention, client computer 200 is a microprocessor-based PC system. Memory device 204 may be any suitable computer readable memory device such as one or more dynamic random access memory (DRAM) devices. Mass storage device 224 may be any suitable computer-readable storage means for storing digital signals such as magnetic storage media (i.e., a magnetic disk), optical storage media (i.e., a CD-ROM or Digital Video Disc), and so forth. Further, client computer 200 may contain various combinations of machine readable storage devices through other I/O controllers, which are accessible by processor 202 and which are capable of storing a combination of computer program instructions and data. Network interface 222 may be any suitable means for controlling communication signals between network devices using a desired set of protocols, services and operating procedures. Those skilled in the art will understand that the communication signals may be received over any suitable medium such as twisted-pair wire, co-axial cable, fiber optics, radio-frequencies, and so forth. Processor 202 may be any suitable means for executing a web browser and the functionality of the client proxy described herein, and is preferably a general purpose microprocessor such as the Pentium®, Pentium Pro, or Pentium II made by Intel Corporation. Monitor 226 may be any means for displaying analog signals, such as a VGA monitor. I/O controllers 220 may be any means for controlling the flow of information between I/O bus 218 and the various I/O devices such as network interface 222, mass storage device 224, monitor 226 and keyboard 228. Bus adapter 206 may be any means suitable for transferring data back and forth between processor/memory bus 216 and I/O bus 218.

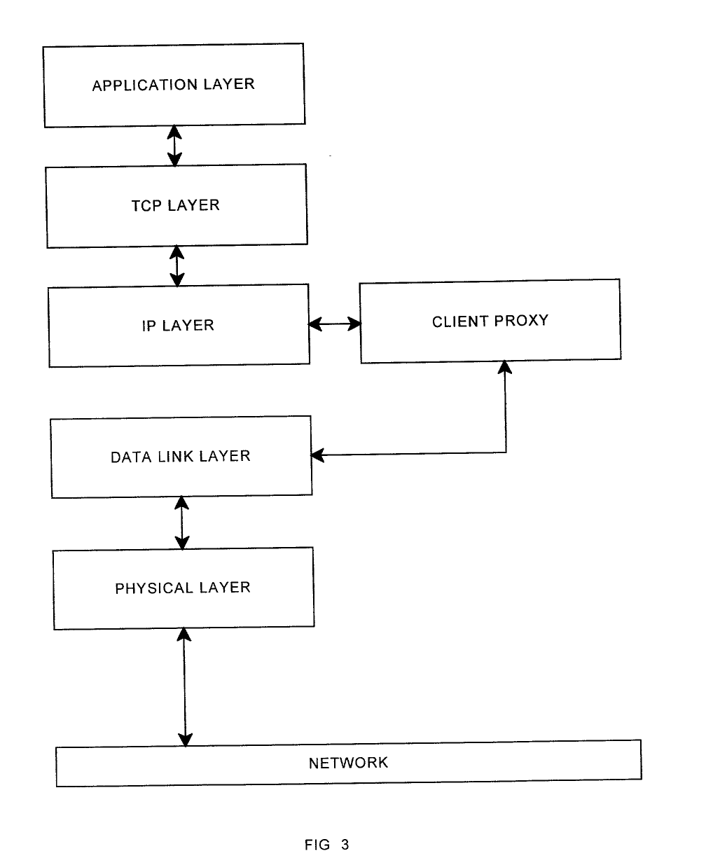

Memory 204 stores computer program segments that when executed by a processor (e.g., processor 202) performs the functionality for this embodiment of the invention. In this embodiment of the invention, the computer program segments related to the functionality of the present invention are separated into three modules, the first module being referred to as a web browser 206, the second module being referred to as a client proxy 208, and the third module being referred to as a helper application 210. Although the computer program segments used in this embodiment of the invention are separated into three modules, it can be appreciated that the functions performed by these modules can be further separated into more modules, combined together to form one module, or be distributed throughout the system, and still fall within the scope of the invention. Further, although this embodiment of the invention implements the functionality of these modules in software, it can be appreciated that the functionality of these modules may be implemented in hardware, software, or a combination of hardware and software, using well-known signal processing techniques. The operation of these modules will be described in further detail later with reference to FIGS. 3-6.

FIG. 3 is a diagram of a IP stack in accordance with one embodiment of the invention. As shown in FIG. 3, the IP stack is comprised of various layers, ranging from the physical layer (layer 1) to the application layer (layer 5). Client proxy 208 is implemented as a peer of the IP layer (layer 3) of the IP stack. Client proxy 208 intercepts packets from the IP layer (layer 3) resident in the client computer, performs source IP address translation on selected packets, and delivers the packets to the data link layer (layer 2). Similarly, client proxy 208 intercepts packets from the data link layer (the data link layer strips off the data link headers prior to delivering the IP packets to the client proxy), performs destination address translation on selected packets, and delivers the packets to the IP layer (layer 3) resident in the client computer.

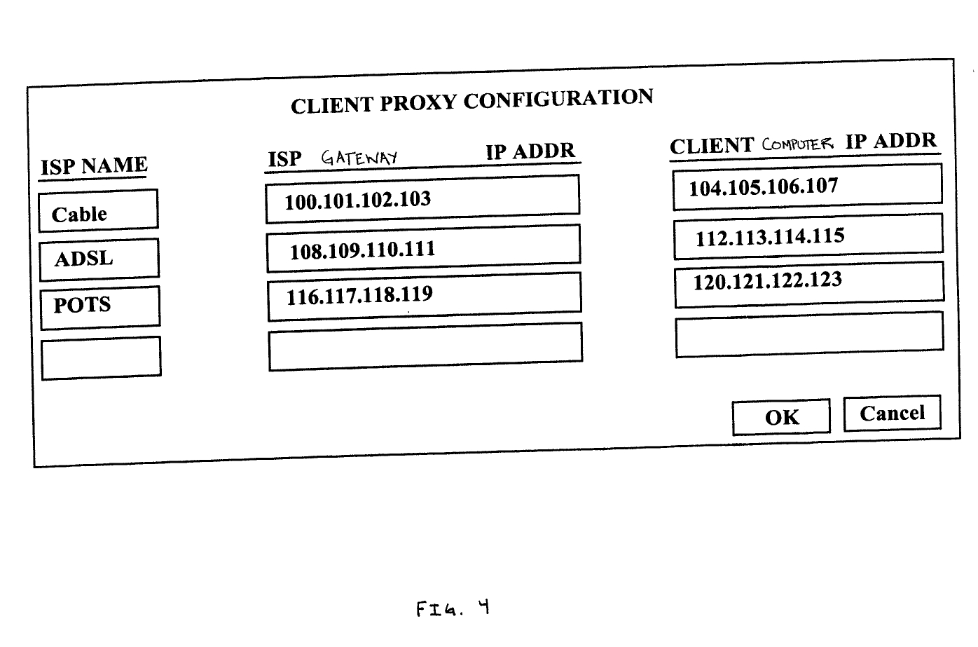

FIG. 4 illustrates a user interface for configuring a client proxy in accordance with one embodiment of the invention. As shown in FIG. 4, the user interface permits a user to enter information for various ISPs into client proxy 208. Examples provided include three ISPs, the first ISP capable of supporting cable modems, the second ISP capable of supporting ADSL modems and the third ISP capable of supporting SLIP or PPP over the plain old telephone system (POTS). Each ISP includes an ISP gateway IP address and a client computer IP address. In this manner, the user need enter the appropriate addresses associated with each ISP only, thereby avoiding the tedious process of reentering 24 numbers for each ISP.

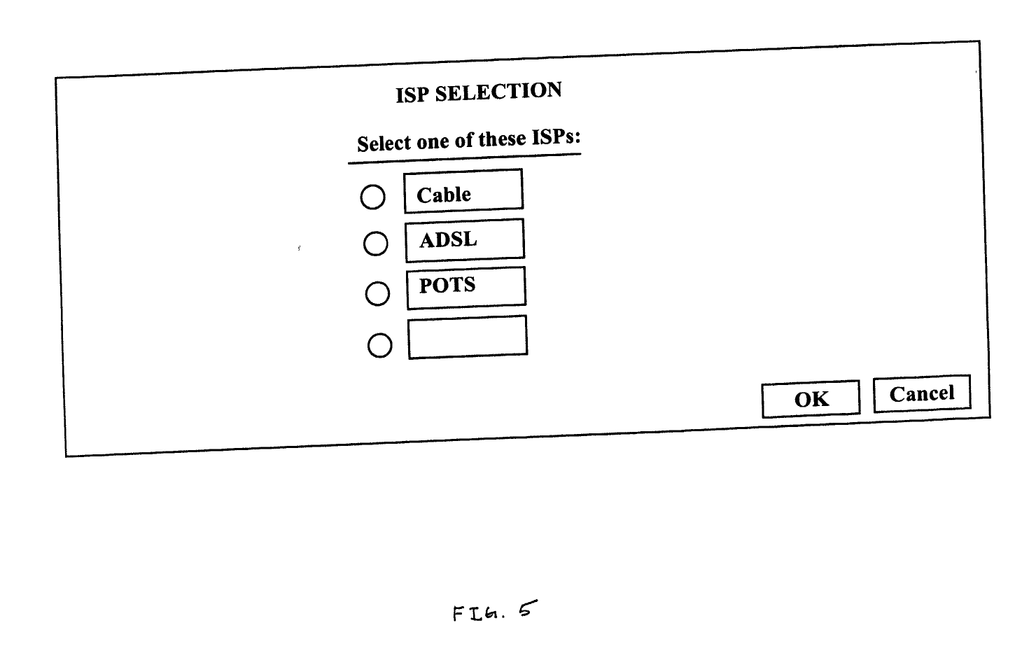

FIG. 5 illustrates a user interface for selecting an ISP in accordance with one embodiment of the invention. As shown in FIG. 5, client proxy 208 uses the information supplied using the user interface described with reference to FIG. 4 to generate another user interface providing a list of ISPs from which the user can select. The user selects an ISP by clicking on the corresponding radio button, and then clicking on the “OK” button. The IP addresses for the client computer and intermediary computer associated with the selected ISP are then stored as part of a translation table used by client proxy 208.

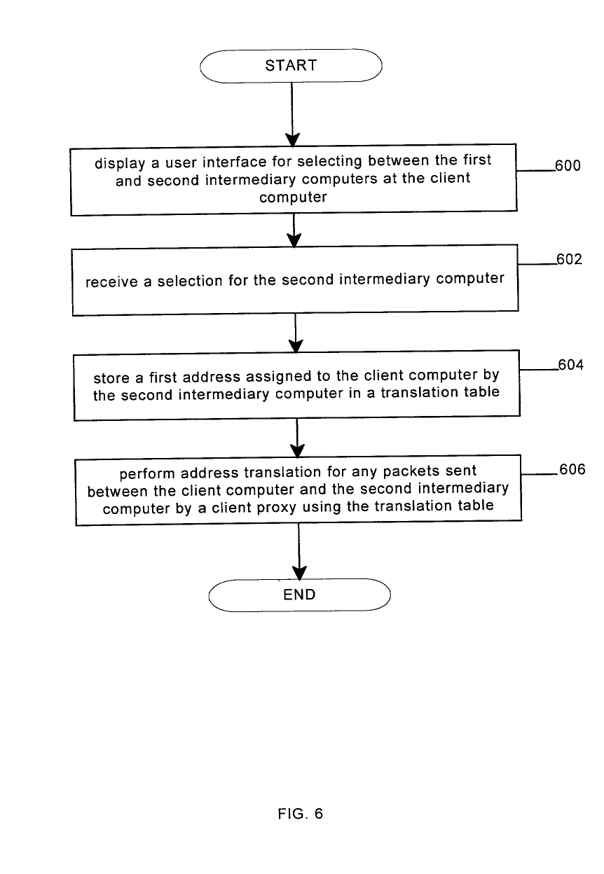

Client proxy 208 performs source address translation for each packet generated by the client computer or destination address translation for each packet received by the client computer. The operation of client proxy 208 is described below with reference to FIG. 6.

FIG. 6 is a block flow diagram of the steps performed in accordance with one embodiment of the invention. As shown in FIG. 6, helper application 210 displays a user interface at step 600 similar to the one described with reference to FIG. 5. The user interface permits a user to select an ISP by clicking on a radio button next to the selections. Once an ISP is selected, helper application 210 sends an IP address assigned to the client computer by that selected ISP to client proxy 208. Helper application 210 also sends an IP address for the ISPG controlled by the selected ISPG to the data link layer (layer 2) of the client computer's IP stack. Client proxy 208 updates the translation table with the client computer's new IP address at step 604. Client proxy 208 performs address translation for selected packets sent between the client computer and the new ISPG using the updated translation table at step 606.

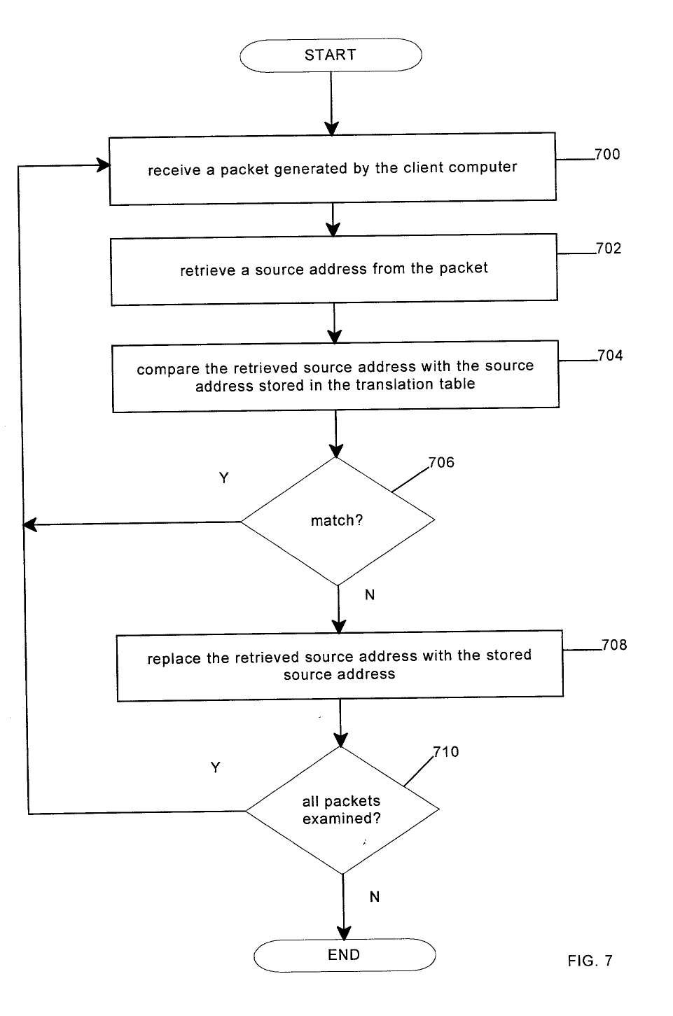

FIG. 7 is a block flow diagram of the operations of a client proxy performing address translation for a packet generated by a client computer in accordance with one embodiment of the invention. As discussed with reference to FIG. 3, each packet generated by the client computer's IP stack are directed to client proxy 208, which operates at layer 3 of the IP stack. At step 700, client proxy 208 receives a packet to perform address translation. Client proxy 208 retrieves a source address from the packet at step 702. Client proxy 208 compares the retrieved source address with an address stored in the translation table at step 704, and performs a test at step 706. If the retrieved source address matches the stored address at step 706, then the packets are correctly addressed and no address translation is performed. Client proxy 208 then selects the next packet to translate at step 700. If the retrieved source address, however, does not match the stored address at step 706, then client proxy 208 replaces the retrieved source address with the stored address at step 708. If all the packets have been examined at step 710, then address translation ends. If all the packets have not been examined at step 710, then address translation continues with the next selected packet at step 700.

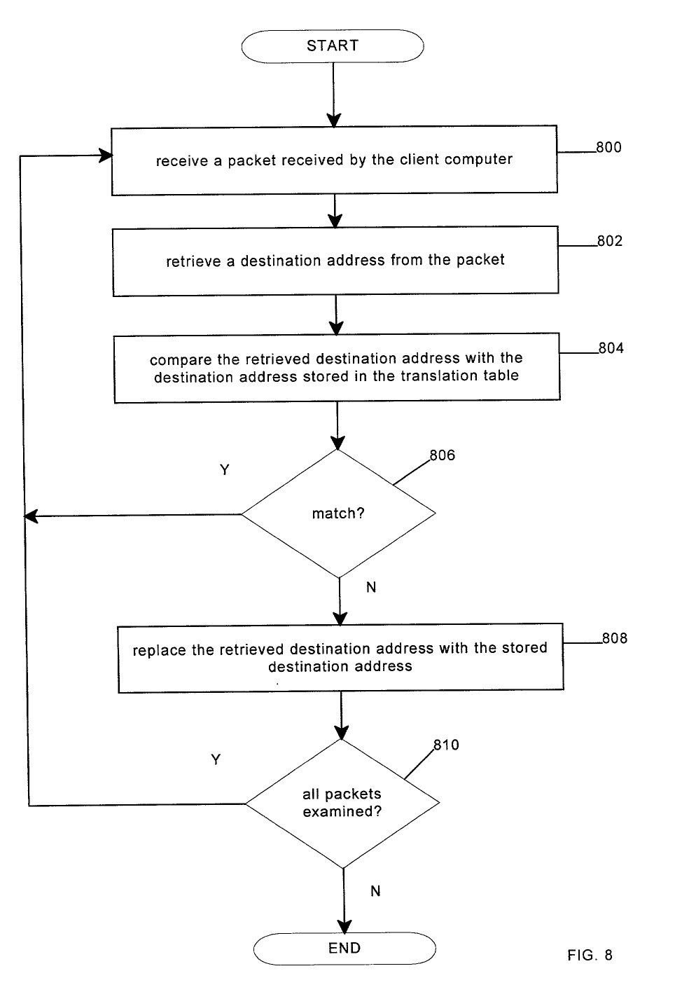

FIG. 8 is a block flow diagram of the operations of a client proxy performing address translation for a packet received by a client computer in accordance with one embodiment of the invention. As also discussed with reference to FIG. 3, each packet received by the client computer is sent from the data link layer (layer 2) to client proxy 208. At step 800, client proxy 208 receives a packet to perform address translation. Client proxy 208 retrieves a destination address from the packet at step 802. Client proxy 208 compares the retrieved destination address with the address stored in the translation table at step 804, and performs a test at step 806. If the retrieved destination address matches the stored address at step 806, then the packets are correctly addressed and no address translation is performed. Client proxy 208 then selects the next packet to translate at step 800. If the retrieved destination address, however, does not match the stored address at step 806, then client proxy 208 replaces the retrieved destination address with the stored address at step 808. If all the packets have been examined at step 810, then address translation ends. If all the packets have not been examined at step 810, then address translation continues with the next selected packet at step 800. It is worth noting that the address retrieved by client proxy 208 changes depending on whether the packet was generated or received by the client computer. The address stored in the translation table, however, is the same regardless of whether the packet was generated or received by the client computer.

Although various embodiments are specifically illustrated and described herein, it will be appreciated that modifications and variations of the present invention are covered by the above teachings and within the purview of the appended claims without departing from the spirit and intended scope of the invention.

What is claimed is:

1. A method for switching a connection between a client computer and a first intermediary computer to a connection between the client computer and a second intermediary computer, comprising:
displaying a user interface for selecting between the first and second intermediary computers at the client computer;
receiving a selection for the second intermediary computer;
storing a first address assigned to the client computer by the second intermediary computer in a translation table; and
performing address translation for packets communicated between the client computer and the second intermediary computer by a client proxy using said translation table.

2. The method of claim 1, wherein said address is an internet protocol address.

3. The method of claim 1, wherein said client proxy and translation table reside in memory for the client computer.

4. The method of claim 1, wherein said performing comprises:
receiving said packets by said client proxy, with each received packet having a second address;
retrieving said first address from each packet;
comparing said first address with said second address; and
replacing said second address with said first address in accordance with said comparison.

5. The method of claim 4, wherein said packets are generated by the client computer, and said first address is a source address for the client computer.

6. The method of claim 4, wherein said packets are received by the client computer, and said first address is a destination address for the client computer.

7. The method of claim 1, further comprising sending a third address associated with the second intermediary computer to an internet protocol stack of the client computer.

8. The method of claim 1, wherein the second intermediary computer is managed by an Internet Service Provider.

9. A machine-readable medium whose contents cause a computer system to switch a connection between a client computer and a first intermediary computer to a connection between the client computer and a second intermediary computer, by performing the steps of:
displaying a user interface for selecting between the first and second intermediary computers at the client computer;
receiving a selection for the second intermediary computer;
storing a first address assigned to the client computer by the second intermediary computer in a translation table; and
performing address translation for packets communicated between the client computer and the second intermediary computer by a client proxy using said translation table.

10. The machine-readable medium of claim 9, wherein said address is an internet protocol address.

11. The machine-readable medium of claim 9, wherein said client proxy and translation table reside in memory for the client computer.

12. The machine-readable medium of claim 9, wherein said performing comprises:
receiving said packets by said client proxy, with each received packet having a second address;
retrieving said first address from each packet;
comparing said first address with said second address; and
replacing said second address with said first address in accordance with said comparison.

13. The machine-readable medium of claim 12, wherein said packets are generated by the client computer, and said first address is a source address for the client computer.

14. The machine-readable medium of claim 12, wherein said packets are received by the client computer, and said first address is a destination address for the client computer.

15. The machine-readable medium of claim 9, further comprising sending a third address associated with the second intermediary computer to an internet protocol stack of the client computer.

16. The machine-readable medium of claim 9, wherein the second intermediary computer is managed by an Internet Service Provider.

17. A method for performing address translation, comprising:
selecting a packet that has been communicated between a client computer and an intermediary computer, said packet having an address;
receiving said packet by a client proxy;
retrieving said address from said packet;
comparing said retrieved address with an address stored in a translation table; and
replacing said retrieved address with said stored address in accordance with said comparison.

18. An apparatus for packet address translation, comprising:
a client computer;
an intermediary computer;
a network connecting said client and intermediary computers, said network communicating packets between said computers; and
a client proxy residing at said client computer, said client proxy performing address translation for said packets.
